(19) United States
(12) Patent Application Publication
(10) Pub. No.: US 2011/0117309 A1
(43) Pub. Date: May 19, 2011

(54) BIOMIMETIC TENDON-REINFORCED (BTR) COMPOSITE MATERIALS

(75) Inventors: Zheng-Dong Ma, Dexter, MI (US); Yushun Cui, Ann Arbor, MI (US)

(73) Assignee: MKP Structural Design Associates, Inc.

(21) Appl. No.: 12/619,211

(22) Filed: Nov. 16, 2009

(51) Int. Cl. B32B 3/00; B32B 5/12

(52) U.S. Cl. 428/77; 428/112

(57) ABSTRACT

Biomimetic tendon-reinforced” (BTR) composite structures feature improved properties including a very high strength-to-weight ratio. A basic structure comprises a plurality of spaced-apart stuffer members, each having a first end and a second end defining a length. A plurality of tendon elements interconnect with the first and second ends of the stuffer members in alternating fashion, such that the tendon elements criss-cross each other between the stuffer members. A first panel is bonded or attached to the first ends of the stuffer members, and a second panel is bonded or attached to the second ends of the stuffer members. In the preferred embodiments, the first panel, the second panel, or both the first and second panels are curved. An efficient manufacturing process based upon hollow stuffers and tendon elements in the form of bent wires is also disclosed.

### FIELD OF THE INVENTION

This invention relates generally to composite materials and, in particular, to biomimetic tendon-reinforced (BTR) composite materials having improved properties including a very high out-plane stiffness and strength-to-weight ratio.

### BACKGROUND OF THE INVENTION

Composite structures of the type, for example, for military air vehicles are generally constructed from a standard set of product forms such as pre-preg tape and fabric, and molded structures reinforced with unidirectional, woven or braided fabrics. These materials and product forms are generally applied in structural configurations and arrangements that mimic traditional metallic structures. However, traditional metallic structural arrangements rely on the isotropic properties of the metal, while composite materials provide the capability for a high degree of tailoring that should provide an opportunity for very high structural performance-to-weight ratio.

There is general confidence among the composite materials community that a high-performance all-composite lightweight aircraft can be designed and built using currently available manufacturing technology, as evidenced by aircraft such as the F-117, B-2, and AVTEK 400. However, composite materials can be significantly improved if an optimization tool is used to assist in their design. In the recent past, engineered (composite) materials have been rapidly developed [1-3]. Maturing manufacturing techniques can easily produce a large number of new improved materials. In fact, the number of new materials with various properties is now reported to grow exponentially with time, which results in difficulty in selecting proper materials when designing a new product. [4]

Composite materials should be designed in such a way that they are optimum for their functions in the structural system and for the loading conditions they will experience. A function-oriented material design (FOMD) process was therefore developed at the University of Michigan and MKP Structural Design Associates, Inc.[5-6] The FOMD process employs an advanced structural optimization method, called topology optimization [7]. Using this technique, the topology optimization problem is transformed into an equivalent problem of optimum material distribution by moving material in the design domain to improve the given objective function. By employing a proper optimization algorithm, the optimization process converges to a design that is optimal for the design problem.

The topology optimization technique has been generalized and applied to various areas, including structural designs and material designs [8]. It has also been applied to the design of structures for achieving static stiffness, desired eigenfrequencies, frequency response, reduced vibration and noise, and other static, thermal, and dynamic response characteristics. [e.g., 8-10] Combing the topology optimization technique with the FOMD process makes it possible to design new advanced materials—materials with properties never thought possible.

### SUMMARY OF THE INVENTION

This invention improves upon the existing art by providing biomimetic tendon-reinforced (BTR) composite structures with improved properties including a very high structural performance (including out-plane stiffness) and strength-to-weight ratio. A basic structure comprises a plurality of spaced-apart stuffer members, each having a first end and a second end defining a length. A plurality of tendon elements interconnect with the first and second ends of the stuffer members in alternating fashion, such that the tendon elements criss-cross each other between the stuffer members. A first panel is bonded, stitched, or attached to the first ends of the stuffer members, and a second panel is bonded, stitched, or attached to the second ends of the stuffer members. In the preferred embodiments, the first panel, the second panel, or both the first and second panels include curved shapes suitable for different applications.

The stuffer members may be substantially parallel to one another and of equal or varying lengths. Alternatively, the stuffer members may be aligned along lines extending radially outwardly from a common center point (or multiple common center points, or without any common center point). The first and second panels may or may not be equidistant from one another. One of the panels may have a convex outer surface, with the other panel having a concave outer surface. Alternatively, both of the panels may have convex or concave outer surfaces. As a further alternative, one of the panels may be flat, with the other panel having a convex or concave outer surface. The stuffer members and tendon elements may embedded in a matrix material such as epoxy resin, metallic or ceramic foams, polymers, thermal isolation materials, acoustic isolation materials, and/or vibration-resistant materials.

The tendon elements may be made of carbon fibers, nylon, Kevlar, glass fibers, plant (botanic) fibers (e.g. hemp, flax), metal wires or other suitable materials. The stuffer members are preferably rigid, semi-rigid, or with desired flexibility, and may be solid or hollow components made of metal, ceramic or plastic. One or both of the panels are solid, perforated or mesh-like.

The tendon elements may be tied or otherwise attached to one another where they criss-cross, thereby forming joints. If the stuffer members are tubes, the tendon elements may be oriented through the tubes. Alternatively, the tendon elements may be provided in the form of bent wires, each with a first bent end inserted into the first end of a stuffer member and a second bent end inserted into the second end of a different member.

Both linear and planar structures may be constructed according to the invention. For example, the stuffer members may be arranged in a two-dimensional plane, with the structure further including a panel bonded to one or both of the surfaces forming an I-beam structure. Alternatively, the stuffer members may be arranged in a two-dimensional array such that the ends of the members collectively define an upper and lower surface to which the panels are bonded or attached.

### BRIEF DESCRIPTION OF THE DRAWINGS

FIG. 1A depicts the definition of a design problem to be solved by the invention;

FIG. 1B depicts an optimized structural composite having several key components, including fibers, stuffers, and joints;

FIG. 2 shows how a matrix may be used to enhance strength;

FIG. 3 illustrates fundamental components of the BTR composite, which include tendons, ribs, joints, skin, flesh, and shell;

FIG. 4 shows how the two-dimensional BTR concept is extended to a three-dimensional BTR configuration;

FIG. 5 illustrates an example potential fabrication process;

FIGS. 6a-d shows variations of BTR shapes, including flat, cylindrical, spherical, and cylinder shapes;

FIGS. 7a, b show example prototypes developed for various BTR configurations;

FIG. 8 illustrates BTR concept can be extended to produce a composite armor with added ceramic layer for blast and ballistic protection;

FIG. 9 shows how fiber elements may be passed through stuffer tubes;

FIG. 10 shows elongated panel stuffer members;

FIG. 11 shows a sandwich BTR structure using spheroid stuffer members, at least in one plane;

FIG. 12 illustrates potential knot designs for assembling special BTR composites, including two-dimensional and three-dimensional structures;

FIG. 13 is a drawing which illustrates an embodiment of the invention wherein the stuffer members and tendon elements are disposed between curved panels;

FIG. 14 depicts an embodiment of the invention including two curved panels, one having a radius curvature different than the other;

FIG. 15 is a drawing which shows two curved panels, also with two radii;

FIG. 16 depicts an embodiment of the invention having one flat panel and one panel having a convex outer surface with the stuffer elements being parallel to one another;

FIG. 17 depicts an embodiment of the invention having one flat panel and one panel having a convex outer surface but with the stuffer elements being arranged along lines extending from a common center of curvature;

FIG. 18 depicts an embodiment of the invention having one flat panel and one panel having a concave outer surface;

FIG. 19 shows two curved panels, both having concave outer surfaces with the same radius of curvature;

FIG. 20 illustrates two curved panels, both with concave outer surfaces, but wherein the radius of curvature of one of the panels is different from that of the other;

FIG. 21 depicts an embodiment of the invention having two curved panels with convex outer surfaces and the same radius of curvature;

FIG. 22 shows two curved panels with convex outer surfaces and different radii of curvature;

FIG. 23 shows how panels with complex/compound shapes may be utilized in accordance with the invention;

FIG. 24 shows how, in all embodiments, the stuffer members and tendon elements may be embedded in a matrix material such as a polymer material, foam, rubber, or other filling material;

FIG. 25 shows how, in all embodiments, the stuffer members need not be spaced apart from one another by equal (or unequal) distances;

FIG. 26 shows how, in all embodiments, the tendon elements may be tied, glued or otherwise bonded at the points where they cross, thereby forming “joints;”

FIG. 27A illustrates the use of hollow stuffer members and tendon elements in the form of bent wires;

FIG. 27B shows how the components of FIG. 27A look when assembled from the side view perspective;

FIG. 27C is a top-down view showing four bent-wire tendon elements and a stuffer member having a round cross-section; and

FIG. 27D is a top-down drawing showing four bent-wire tendon elements and a stuffer member having a non-round cross-section, such as a square.

FIG. 28 illustrates additional configurations and options for assembling the stuffer members and bent-wire tendons.

### DETAILED DESCRIPTION OF THE INVENTION

This invention uses a methodology called “function-oriented material design,” or FOMD, to design materials for the specific, demanding tasks. In order to carry out a FOMD, first the functions of a particular structure are explicitly defined, such as supporting static loads, dissipating or confining vibration energy, or absorbing impact energy. These functions are then quantified, so as to define the objectives (or constraint functions) for the optimization process. Additional constraints, typically manufacturing and cost constraints, may also need to be considered in the optimal material design process.

The FOMD system has resulted in a number of innovative structural material concepts, including the BTR (biomimetic tendon-reinforced) composite materials described in this specification. The original concept of the BTR composite was obtained through a topology optimization process which maximizes the out-plane stiffness of a composite made of carbon fiber and epoxy matrix material. The result shows that the fiber should be concentrated and oriented along the most effective load paths identified through the topology optimization process.

According to this new composite concept, which is different from the traditional fiber-reinforced laminate composites, fibers are evenly distributed in the matrix material. The analyses also showed that the materials in tension and materials in compression can be treated differently in the composite, and can be selected and designed separately with respect to their functionalities in the composite material. Additional covering and filling materials can also be added into the composite, and the further development of the concept through prototyping, testing, and developing fabrication method resulted in a wide range of new BTR composites.

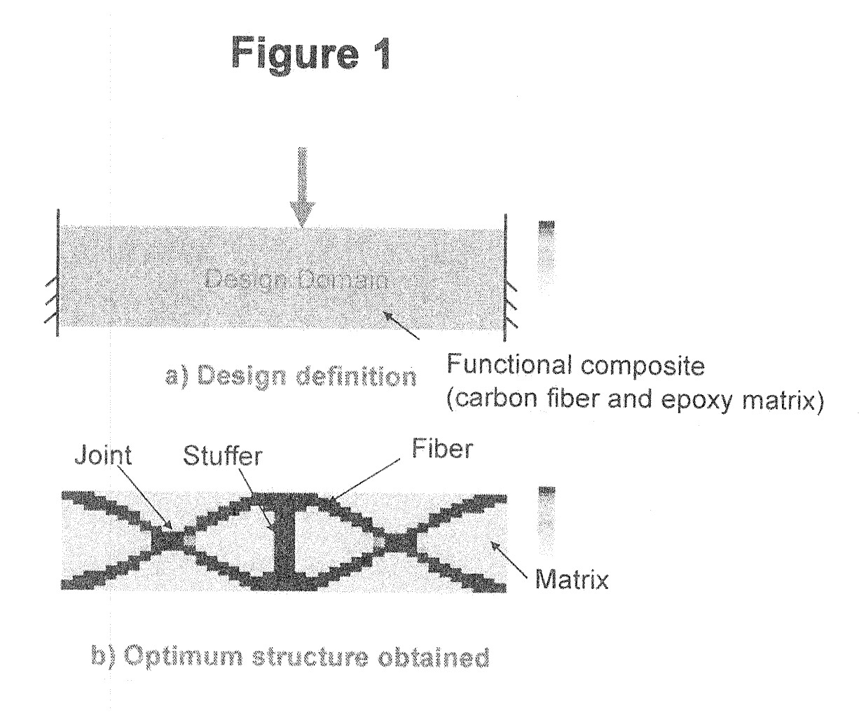

An example BTR design process is illustrated in FIG. 1. The goal here is to optimize the out-plane stiffness of the composite material for a given amount of the fiber and matrix materials. As shown in FIG. 1A, a static load was applied at the middle of a design domain fixed at its two ends. The objective function considered in the optimization problem is to minimize the total strain energy stored in the composite. This is equivalent to maximize the out-of-plane stiffness (resisting the out-of-plane load). FIG. 1B shows the optimum layout of the composite obtained using FOMD methods.

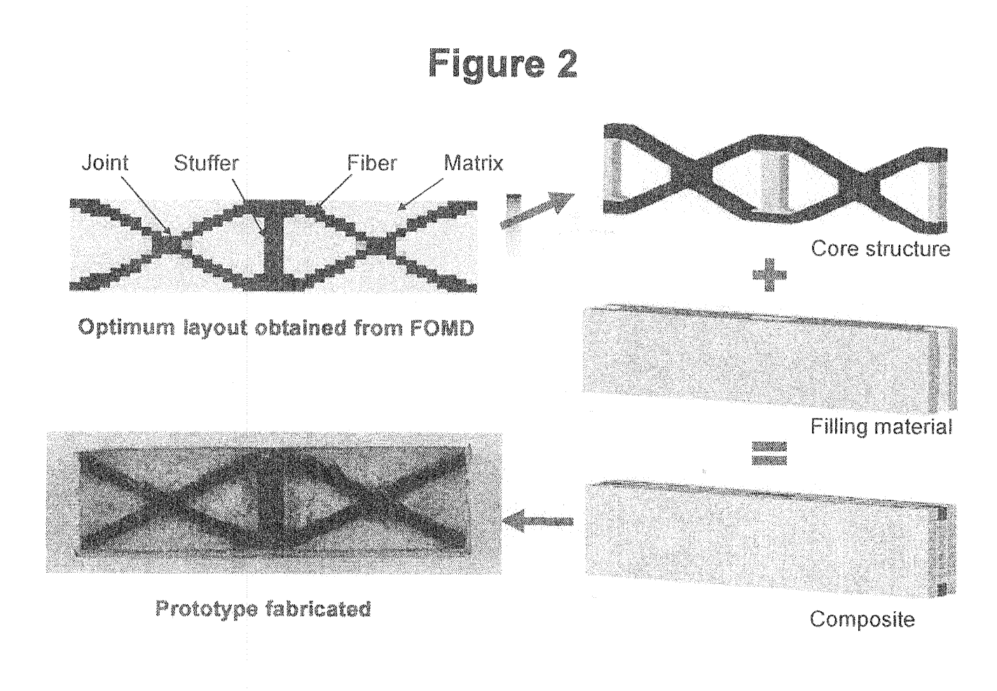

The optimum structural configuration of the composite has several key components, including: fiber, stuffer, and joint, as shown in FIG. 1B. Note that the optimum structure obtained from the concept design implies that the fibers should be concentrated and optimally arranged along the load paths where the reinforcements are most needed. Unlike traditional woven materials, in which the fibers are almost evenly distributed in one plane in the matrix materials, the new material will be reinforced by allocating concentrated fibers, such as fiber ropes, along load paths so as to increase transverse stiffness. In practical applications, a matrix or filling material may (or may not) be used to enhance structural performance, as shown in FIG. 2.

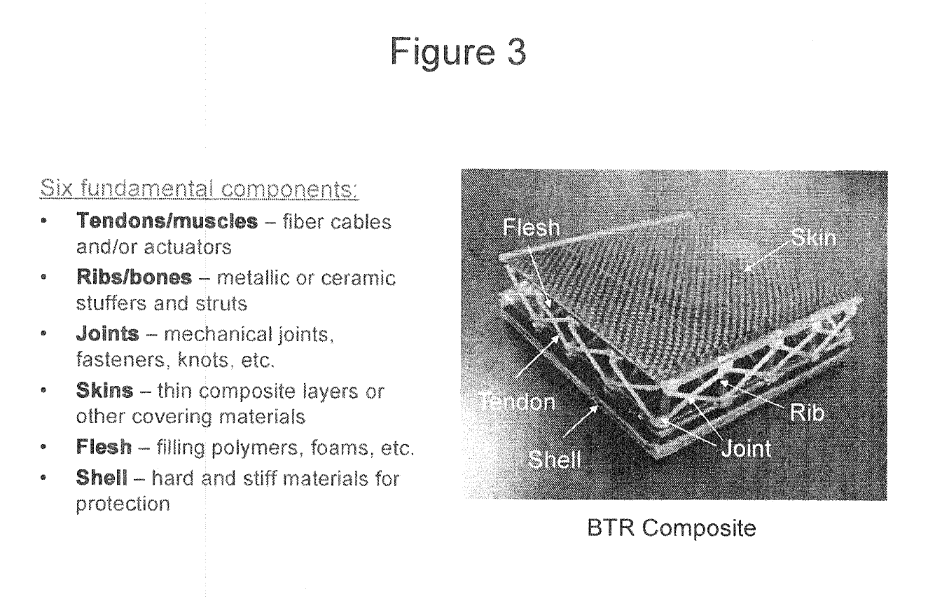

One typical BTR composite structure, shown in FIG. 3, includes six fundamental components: tendons/muscles (represented by fiber cables and/or actuators), ribs/bones (represented by metallic, ceramic, or other stuffers and struts), joints (including knots), flesh (represented by filling polymers, foams, thermal and/or acoustic materials, etc.), skins (represented by woven composite layers or other thin covering materials), and shell (represented by hard and stiff materials, such as metal or ceramic.)

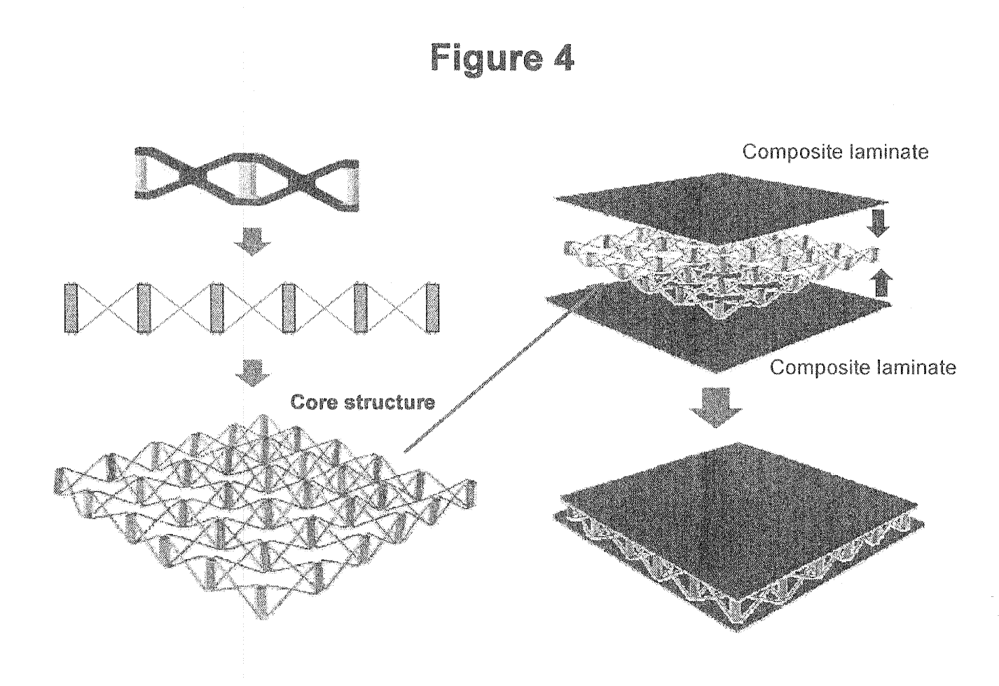

In different embodiments, the two-dimensional material concept may be extended to a three-dimensional lattice, as shown in FIG. 4. The preferred structure is made of various raw materials, for example, steel frame, steel columns, carbon-fiber ropes, and carbon fiber/epoxy cover panels. A potential fabrication procedure is shown in FIG. 5. Here, bent-wire tendon elements 502 are inserted into the ends of stuffer members 504 to create linear structures 506. These, in turn, may be replicated to create a planar structure 510. If panels 512, 514 are added, a lightweight yet rigid structure 516 results.

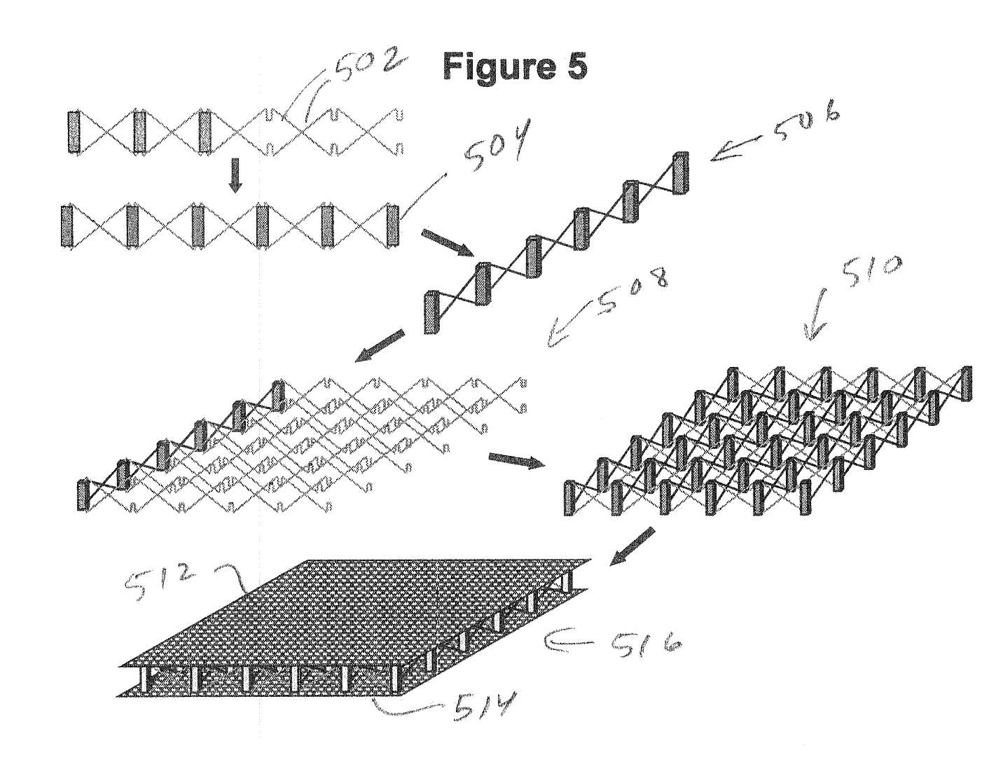

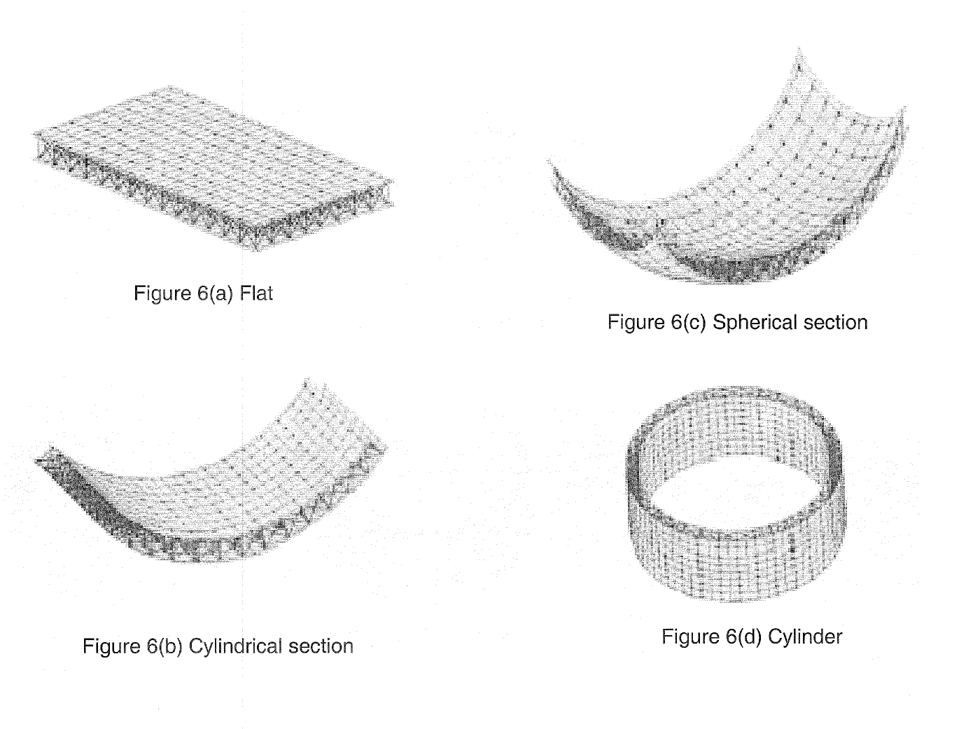

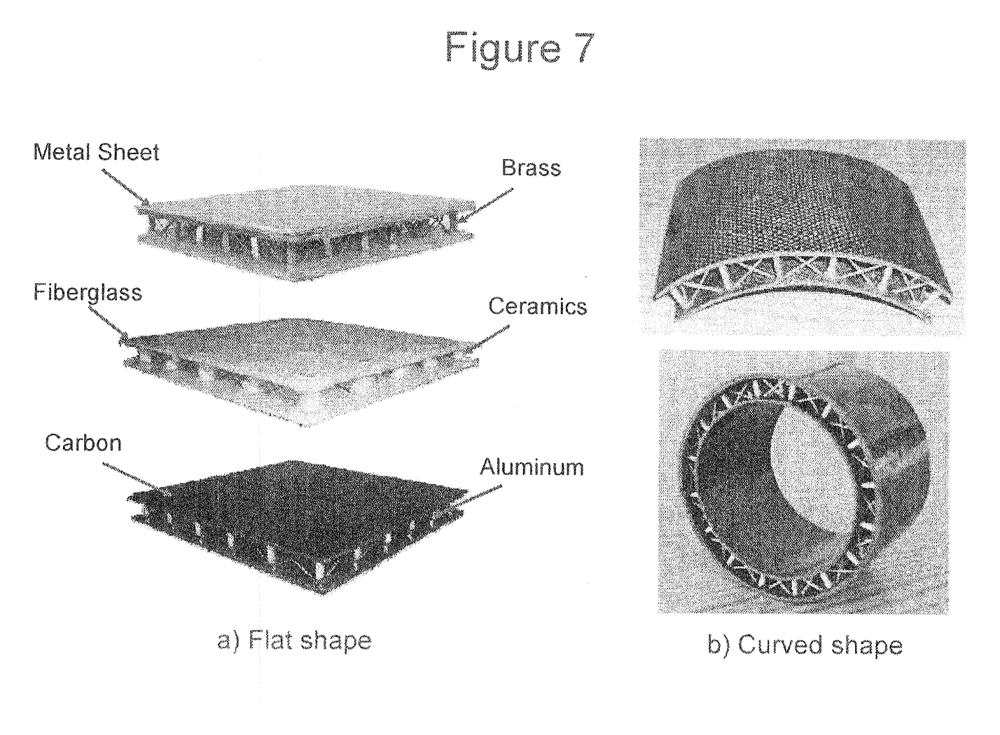

FIG. 6 illustrates possible structures using the basic BTR idea. FIG. 6a shows a flat panel such as that depicted in FIG. 5. FIG. 6b shows a curved cylindrical section, and FIG. 6c shows a curved spherical section. FIG. 6d shows a complete cylinder may be formed using the process. FIG. 7 further illustrates example prototypes with a wide range of material variations.

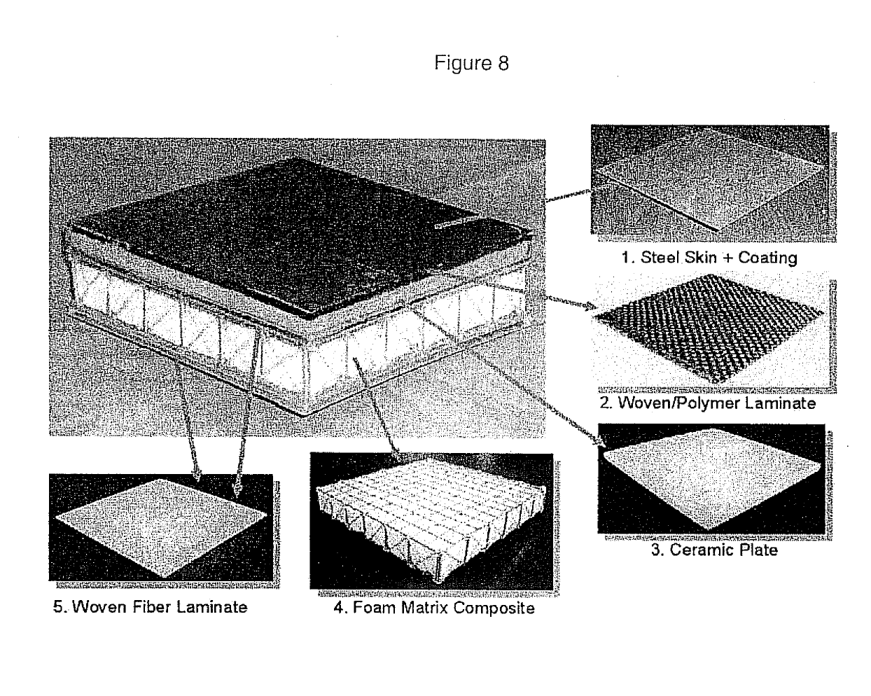

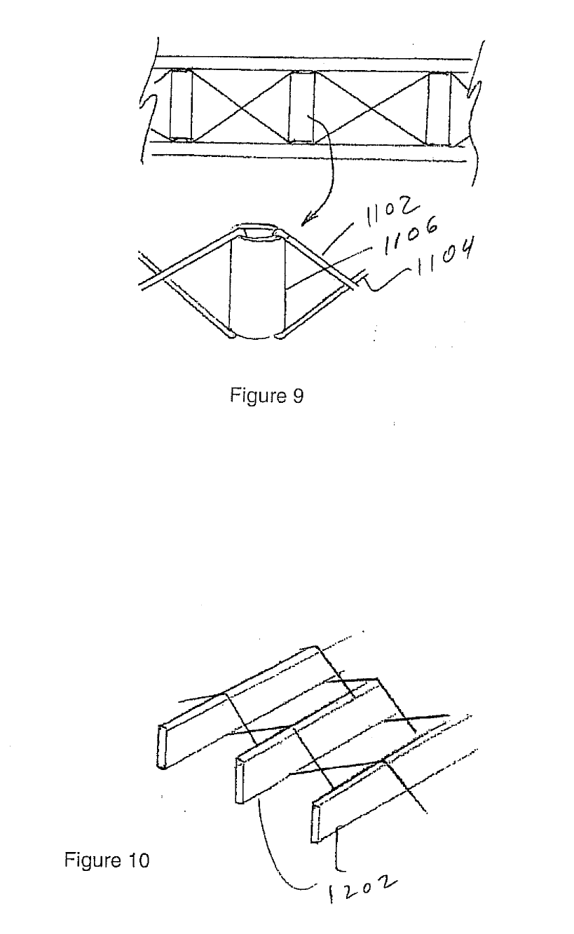

FIG. 8 illustrates a design toolkit developed at MKP Inc., while an example finite element model of the BTR material shown in FIG. 4 is shown in FIG. 9. The top and bottom plates may be metal carbon fiber/epoxy panel layers. The stuffers may be steel, aluminum or ceramic, and the tendon elements may be carbon fiber ropes. The panels are glued to the frames using epoxy to form the final BTR structure as shown in FIG. 4. The dimension of the sample lattice structure is 100 mm×100 mm×12 mm. Note that commercial 1-EA codes can also provide an estimate for the response of the BTR under various loads.

FIG. 8 illustrates an extension of the BTR concept to develop a composite armor, which consists of stuffer, fiber ropes, woven fiber panels, and ceramic layers. Since the BTR structure is ultra-light, the proposed composite armor would benefit the future combat system in the total weight reduction as well as in the energy absorption. The carbon-rope reinforcement plan is optimized to withstand an actual impact.

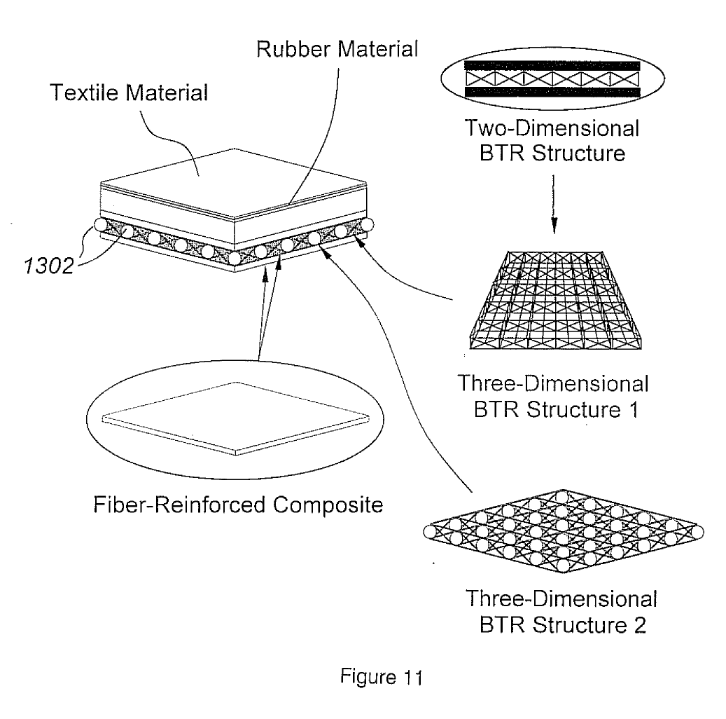

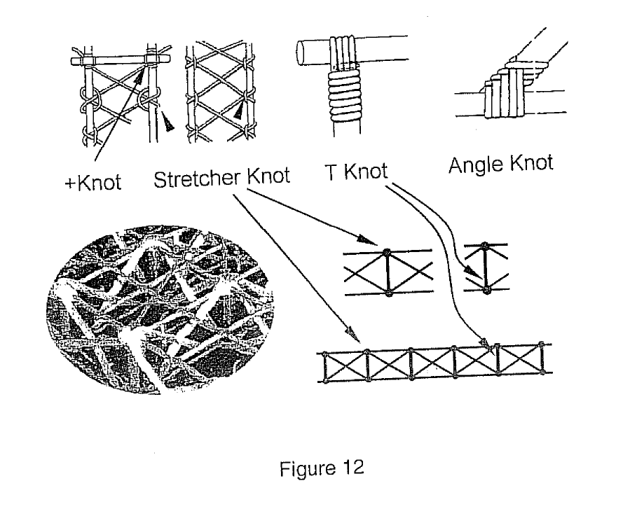

In some BTR structures, the carbon ropes may be stitched to the frame structure. FIG. 9 shows how fiber elements 1102, 1104 may be passed through stuffer tubes 1106. FIG. 10 shows elongated panel stuffer members 1202. FIG. 11 shows a sandwich BTR structure using spheroid stuffer members 1302, at least in one plane. FIG. 12 illustrates potential knot designs for assembling special BTR composites, including two-dimensional and three-dimensional structures.

An advantage of the BTR composite is the use of embedded fiber tendons. When a load carrying carbon-fiber tendon in a well-designed BTR composite is broken, the neighboring fiber tendons can act as the safety members to preserve the integrity of the whole BTR structure provided the tendons are properly placed. In a practical application, several layers of the proposed BTR structure can be stacked together to provide even better out-of-plane performance when needed.

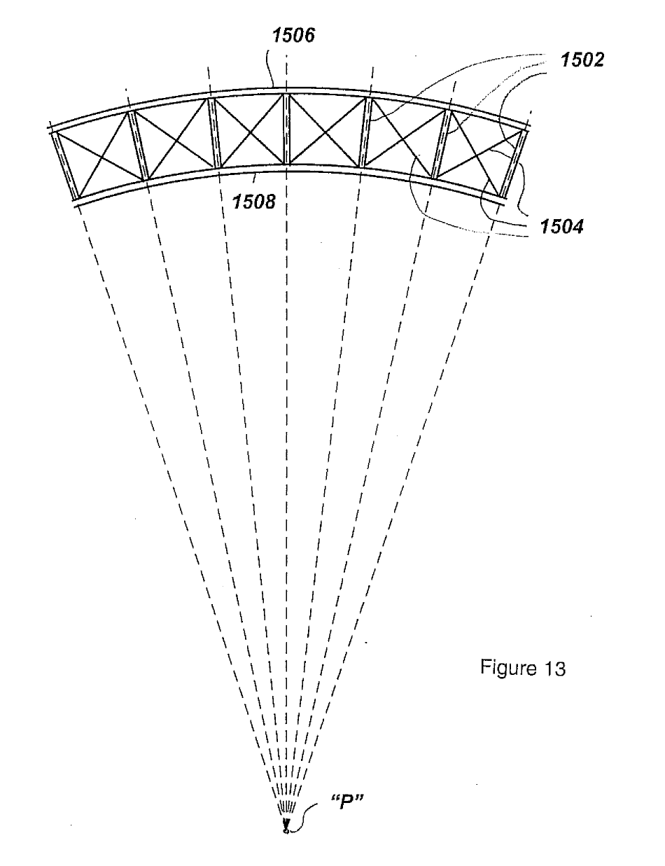

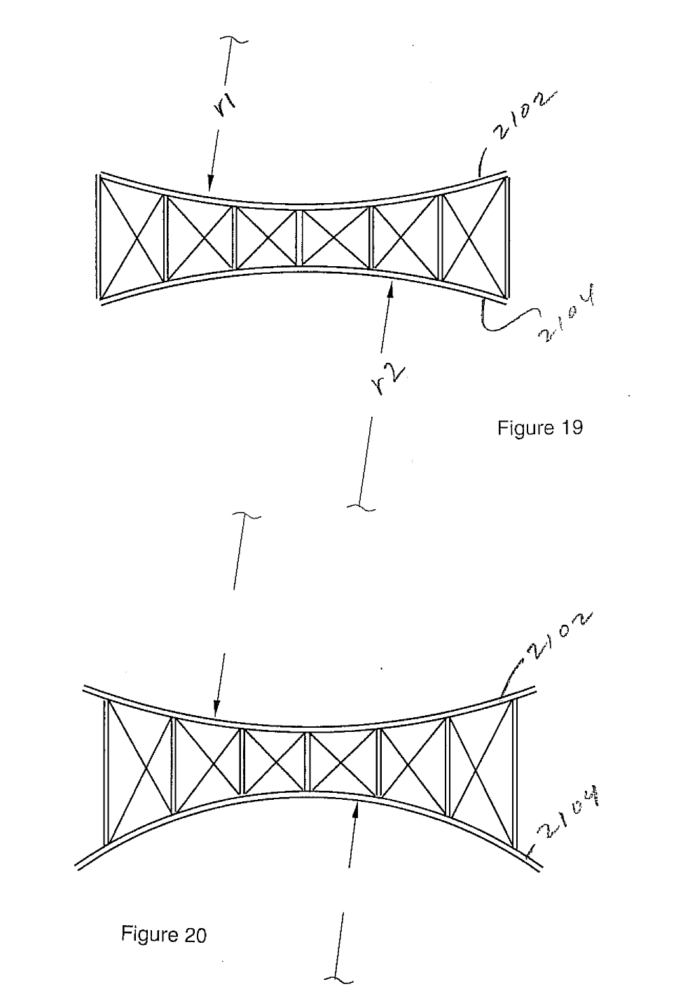

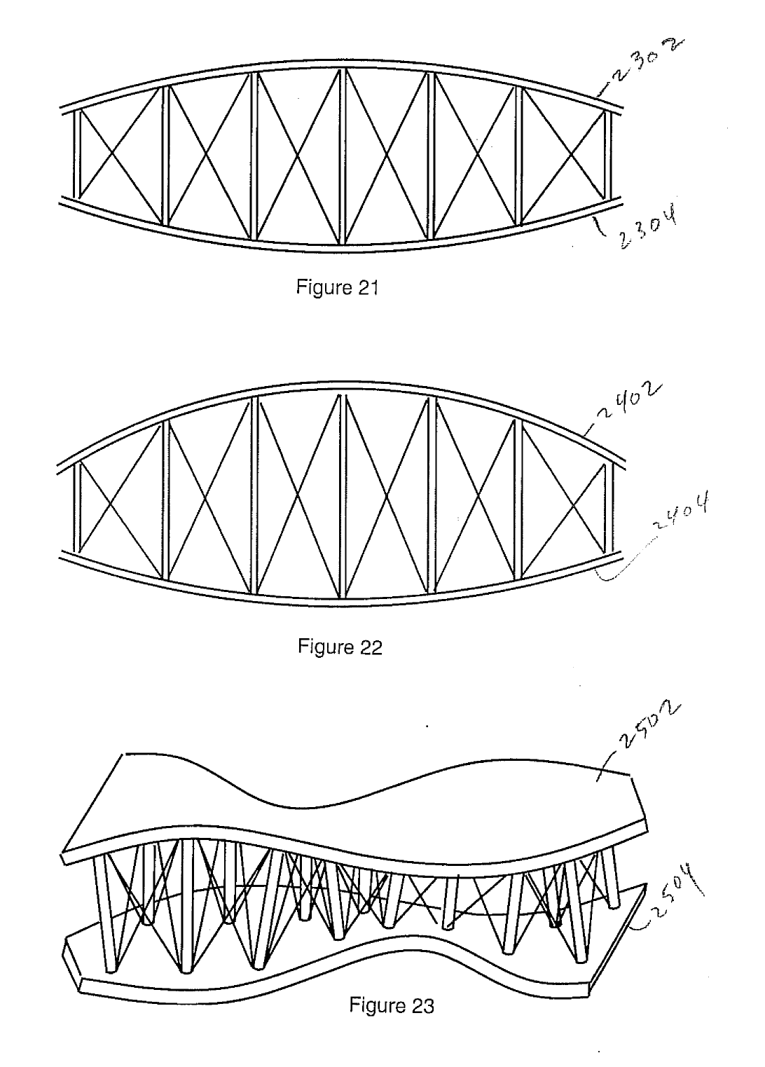

While certain of the embodiments so far described have depicted stuffer members and tendon elements disposed between flat, parallel tiles, non-parallel flat panels and non-flat panels may alternatively be used. As one example, FIG. 13 illustrates an embodiment wherein the stuffer members (i.e., 1502) and tendon elements (i.e., 1504) are disposed between curved panels 1506, 1508. In this case, panels 1506, 1508 share a common radius of curvature from point “p” such that the panels are equidistant. Further in this embodiment the stuffer members are uniformly spaced and aligned along spokes extending radially outwardly from the common center point. Although a 2-dimensional structure is shown (i.e., one set of stuffer members in a plane), it will be appreciated that in this and all other embodiments 3-dimensional structures may be used, in which case addition groups of stuffers would be present in the spaces into and/or out of the plane. Additionally, although panels 1506, 1508 are hemispherical, in this and all other embodiments using curved panels, non-hemispherical surfaces may be used, including parabolic, hyperbolic, and compound surfaces as shown in FIG. 21.

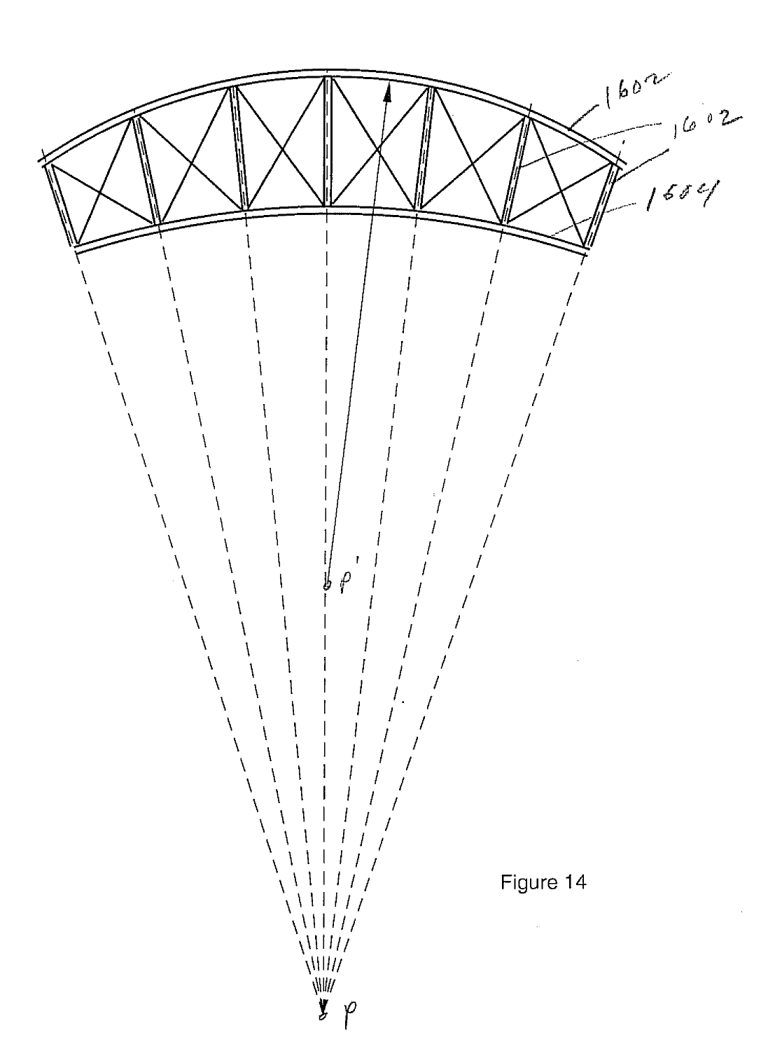

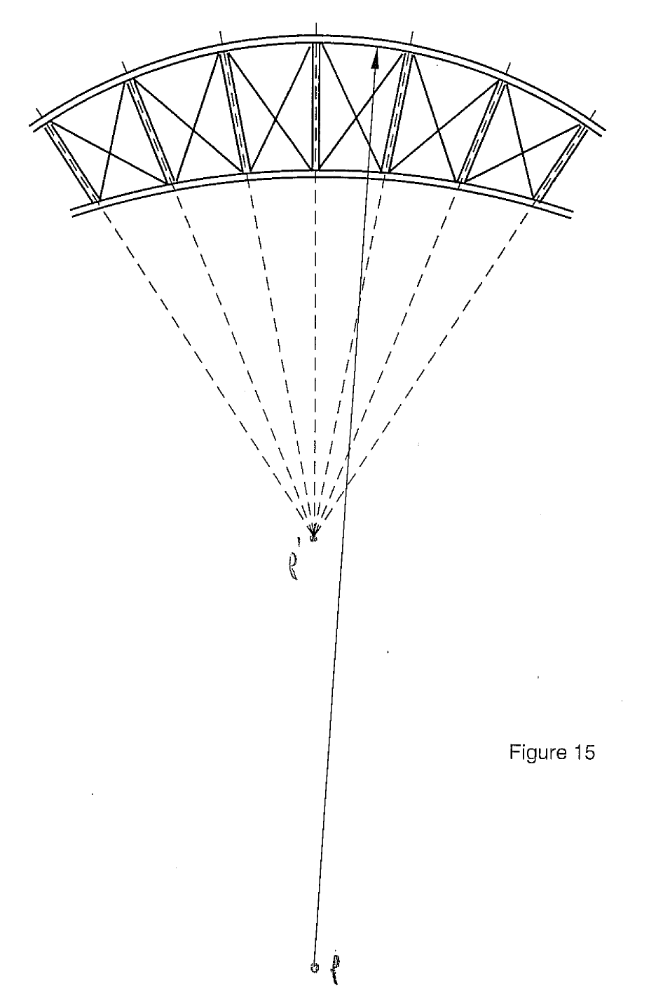

FIG. 14 depicts an embodiment of the invention including two curved panels, 1602, 1604 one having a radius curvature from point “p” and the other having a different radius of curvature based upon “p′.” The stuffer members are shown extending radially outwardly from point “p” but in this case they vary in length because the panels are not equally spaced apart. FIG. 15 is a drawing which shows two curved panels, also with two radii, but in this case the stuffers are aligned along spokes emanating from “p′.” Other stuffer alignments are possible, including arrangements based upon a center of curvature other than “p” and “p′,” including a center midway between them.

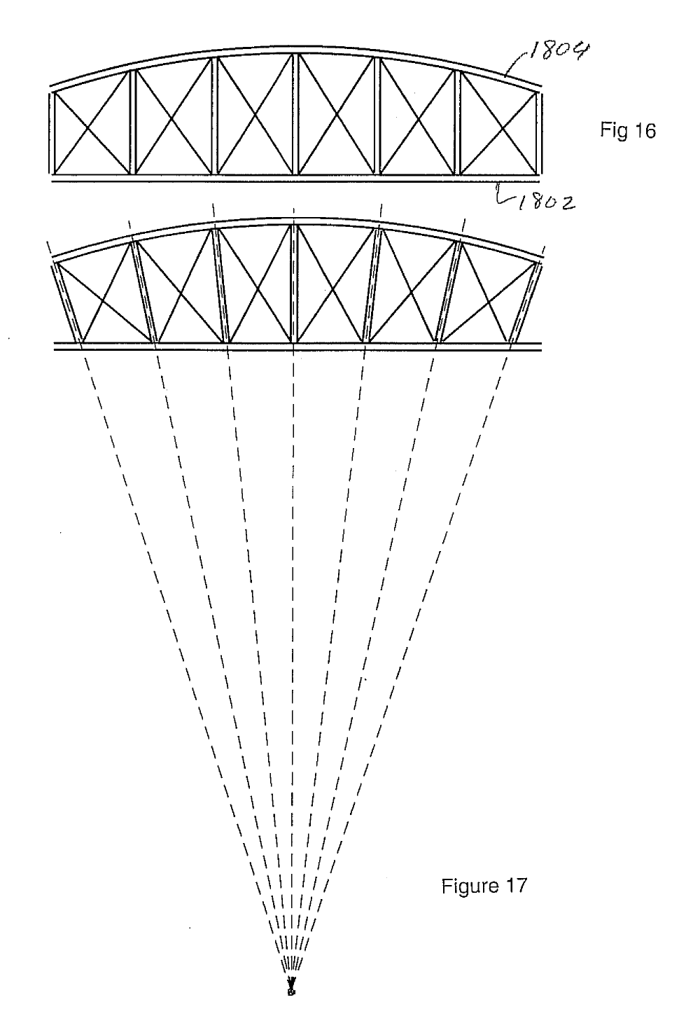

Curved and flat panels may also be intermixed in accordance with the invention. FIG. 16 for example depicts an embodiment of the invention having one flat panel 1802 and one panel 1804 having a convex outer surface. In this case the stuffer elements are parallel to one another, but as shown in FIG. 17, the stuffers may be arranged along lines extending from a common center of curvature.

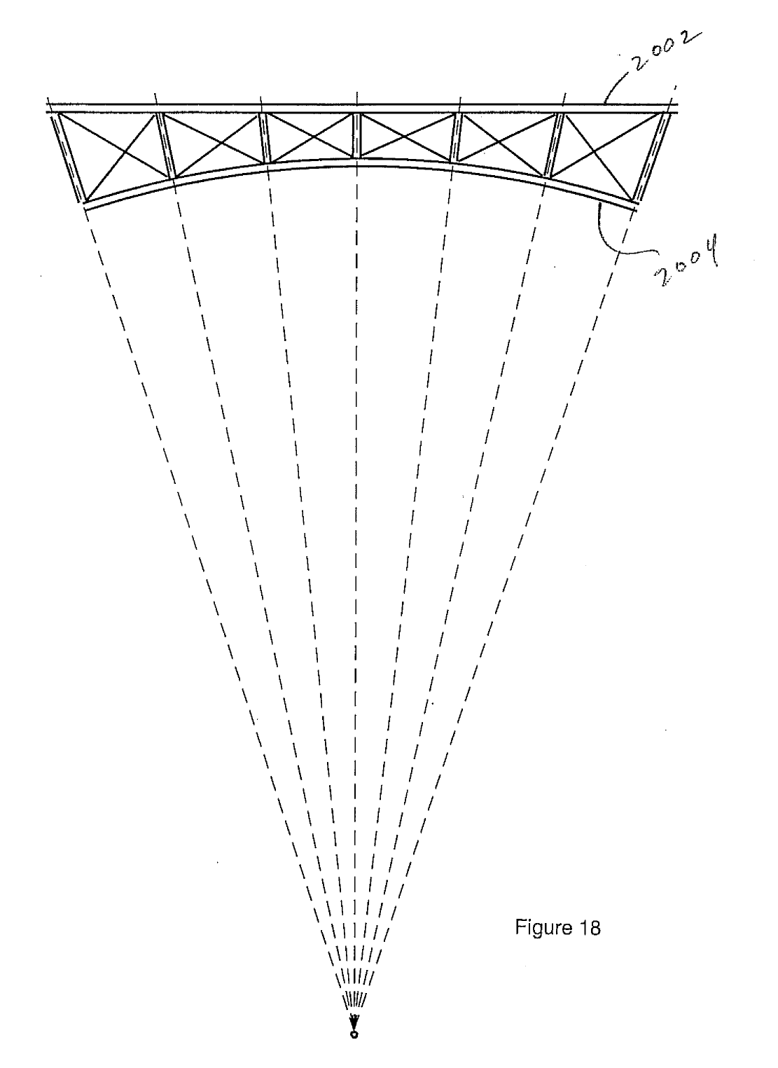

FIG. 18 depicts an embodiment of the invention having one flat panel 2002 and one panel 2004 having a concave outer surface. The stuffers are arranged along lines extending from a common center of curvature, but other arrangements may be used including parallel positioning.

FIG. 19 shows two curved panels 2102, 2104, both having concave outer surfaces with the same radius of curvature (i.e., r1=r2). FIG. 20 illustrates two curved panels, both with concave outer surfaces, but wherein the radius of curvature of one of the panels is different from that of the other (i.e., r1≠r2). FIG. 21 depicts an embodiment of the invention having two curved panels 2302, 2304 with convex outer surfaces and the same radius of curvature, whereas FIG. 22 shows two curved panels with convex outer surfaces and different radii of curvature. The stuffers are preferably parallel in the embodiments of FIGS. 19-22.

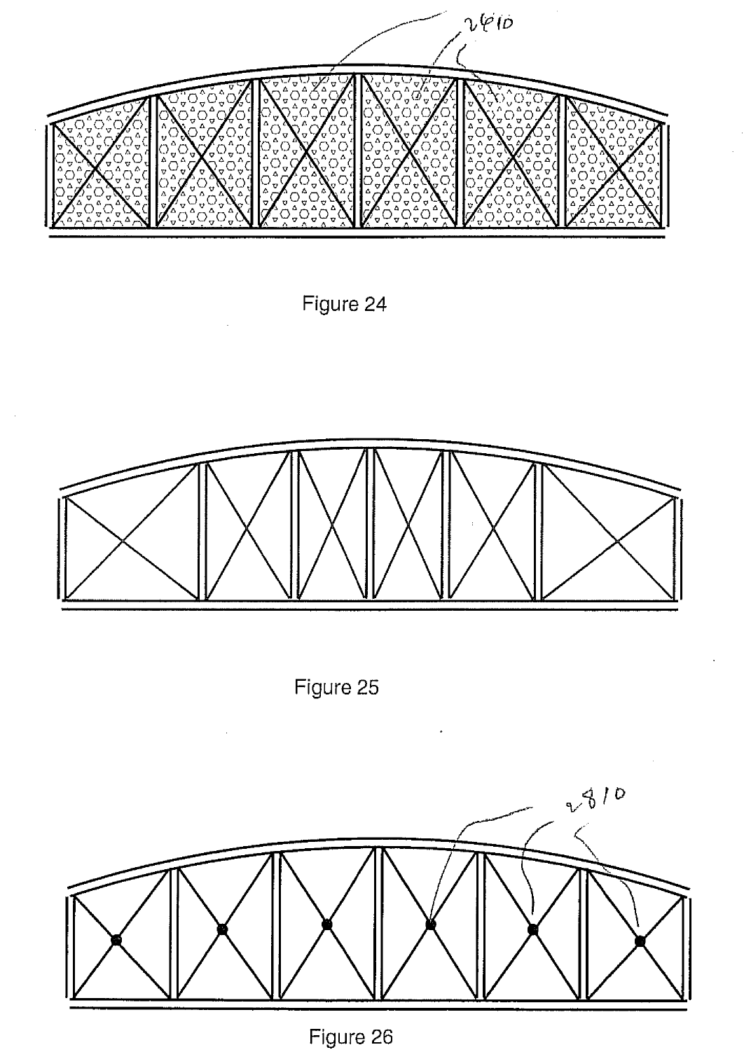

FIG. 23 shows how panels 2502, 2504 with complex/compound shapes may be accommodated in accordance with the invention. Such structures may be optimized, for example, to fabricate vehicular, aerospace and marine body parts. FIG. 24 shows how, in all embodiments, the stuffer members and tendon elements may be embedded in a hardened matrix material 2610 such as epoxy. FIG. 25 shows how, in all embodiments, the stuffer members need not be spaced apart from one another by equal distances, and FIG. 26 shows how, in all embodiments, the tendon elements may be tied, stitched, glued, or otherwise bonded at the points where they cross, thereby forming “joints” 2810.

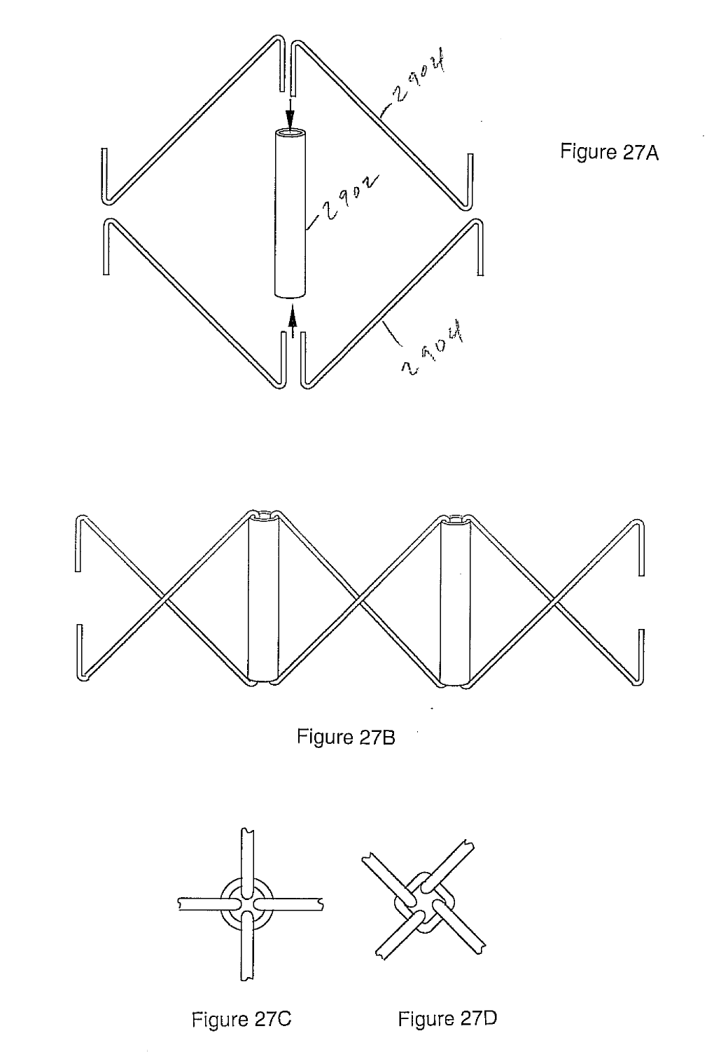

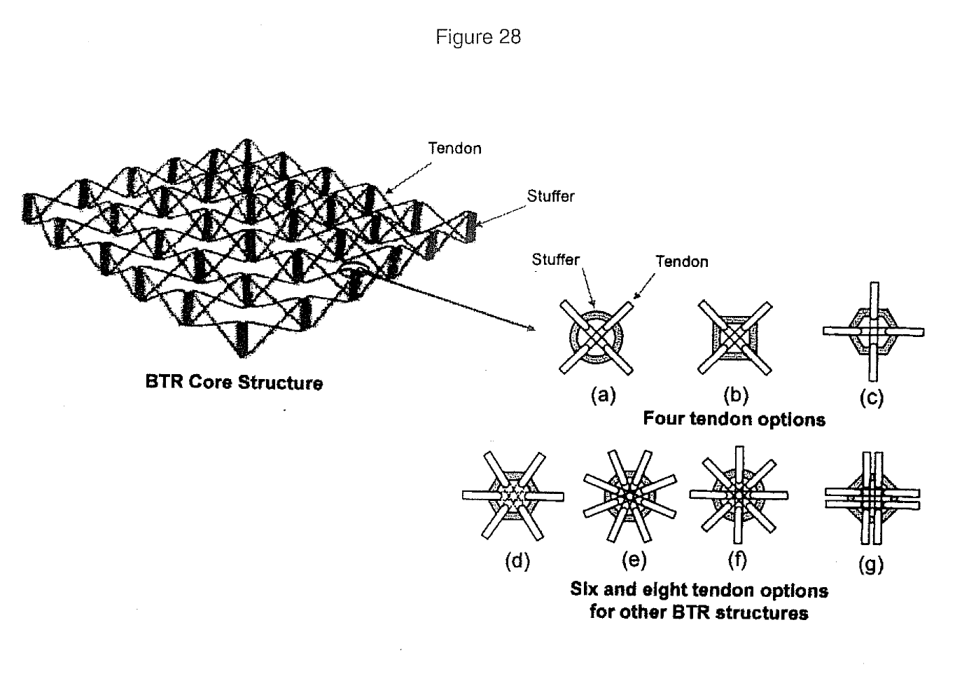

FIG. 27A illustrates the use of hollow stuffer members 2902 and tendon elements in the form of bent wires 2904. FIG. 27B shows how the components of FIG. 27A appear when assembled from a side view perspective. FIG. 27C is a top-down view showing four bent-wire tendon elements and a stuffer member having a round cross-section, and FIG. 27D is a top-down drawing showing four bent-wire tendon elements and a stuffer member having a non-round cross-section, such as a square. The use of hollow stuffer members and bent-wire tendons simplifies manufacture and may even be automated using pick-and-place robotics, for example. FIG. 28 illustrates additional configurations and options for assembling the stuffer members and bent-wire tendons. In all bend-wire configurations, small pieces such as those shown in FIGS. 27A-27D may be used or, alternatively, the longer pieces of FIG. 5 may be used.

As with all embodiments described herein, the staffers may be composed of any suitable materials, including ceramic, metal or plastic, preferably semi-rigid or rigid. Although four bent-wire tendon elements are shown inserted into each end of the stuffer members, other arrangements such as three tendon elements may be used, in which case a top-down view of a two-dimensional structure could show multiple triangles or hexagons as opposed to squares, diamonds or parallelograms. It will also be appreciated that the use of hollow stuffer members and bend-wire tendons are not limited to structures including one or more curved plates, in that the stuffers and tendons may be sandwiched between parallel plates or tiles as shown in FIG. 6, for example.

### REFERENCES

1. Wojciechowski, S., “New trends in the development of mechanical engineering materials,” Journal of Materials Processing Technology, Vol. 106, pp. 230-235 (2000).
2. Cherradi, N., Kawasaki, A., and Gasik, M., “World Trends in Functional Gradient Materials Research and Development,” Composite Engineering, Vol. 4, No. 8, pp. 883-894 (1994).
3. Ashby, M. F., et al., Metal Foams: A Design Guide, Butterworth-Heinemann, 2000.
4. Ashby, M. F., Materials Selection in Mechanical Design, Pergamon Press, Oxford, D.C., (1992).
5. Ma, Z.-D., Wang, H., Kikuchi, N., Pierre, C., and Raju, B, “Function-Oriented Material Design for Next-Generation Ground Vehicles,” Symposium on Advanced Automotive Technologies, 2003 ASME International Mechanical Engineering Congress & Exposition, Nov. 15-21, 2003, Washington, D.C., IMECE2003-43326.
6. Ma, Z.-D., Jiang, D., Liu, Y., Raju, B., and Bryzik, W., “Function-Oriented Material Design for Innovative Composite Structures against Land Explosives,” 25th Army Science Conference, Nov. 27-30, 2006, Orlando, Fla.
7. Bendsøe, M. P. and Kikuchi, N., “Generating optimal topologies in structural design using a homogenization method,” Comput. Methods Appl. Mech. Energ. Vol. 71, pp. 197-24 (1988).
8. Bendsøe, M. P., Optimization of Structural Topology, Shape, and Material, Springer-Verlag Berlin Heidelberg, 1995.
9. Ma, Z.-D., Kikuchi, N., and Cheng, H.-C., “Topological Design for Vibrating Structures,” Computer Methods in Applied Mechanics and Engineering, Vol. 121, pp. 259-280 (1995).
10. Ma, Z.-D., Kikuchi, N., Pierre, C., and Raju, B., 2006, “A Multi-Domain Topology Optimization Approach for Structural and Material Designs,” ASME Journal for Applied Mechanics, Vol. 73, No. 4, pp. 565-573 (2006).

We claim:

1. A biomimetic tendon-reinforced (BTR) composite structure, comprising:
a plurality of spaced-apart stuffer members, each having a first end and a second end defining a length;
a plurality of tendon elements interconnecting the first and second ends of the stuffer members in alternating fashion such that the tendon elements criss-cross each other between the stuffer members;
a first panel attached to the first ends of the stuffer members;
a second panel attached to the second ends of the stuffer members; and
wherein the first panel, the second panel, or both the first and second panels are curved.

2. The composite structure of claim 1, wherein the spaced-apart rigid stuffer members are arranged in a two-dimensional array.

3. The composite structure of claim 1, wherein the stuffer members are substantially parallel to one another but of varying lengths.

4. The composite structure of claim 1, wherein the stuffer members are aligned along lines extending radially outwardly from a common center point.

5. The composite structure of claim 1, wherein the stuffer members are of substantially the same length (or at different length), with each being aligned along lines extending radially outwardly from a common center point (or multiple center points or no common center point).

6. The composite structure of claim 1, wherein the first and second panels are substantially parallel to one another.

7. The composite structure of claim 1, wherein one of the panels has a convex outer surface and the other panel has a concave outer surface.

8. The composite structure of claim 1, wherein both of the panels have convex or concave outer surfaces.

9. The composite structure of claim 1, wherein one of the panels is flat and the other panel has a convex or concave outer surface.

10. The composite structure of claim 1, wherein the stuffer members and tendon elements are embedded in a solid matrix material, fluid, compressed fluid or air.

11. The structure of claim 1, wherein the stuffer members and tendon elements are embedded in an epoxy resin, foam, sand, organic or inorganic materials, thermal isolation materials, vibration or sound isolation materials.

12. The structure of claim 1, wherein the stuffer members are substantially rigid or with a desired flexibility.

13. The structure of claim 1, wherein the stuffer members are solid or hollow.

14. The structure of claim 1, wherein the stuffer members are metal, ceramic, plastic, bamboo, wood, stone, organic, or inorganic materials.

15. The structure of claim 1, wherein the stuffer members are spaced apart at equal distances or at variable distances determined through optimization.

16. The structure of claim 1, wherein the tendon elements are organic or inorganic fibers: carbon fibers, nylon, aramid fibers, glass fibers, plant fibers; or metal wires.

17. The structure of claim 1, wherein the tendon elements are tied (or not tied) to one another where they criss-cross, forming joints.

18. The structure of claim 1, wherein:
the stuffer members are tubes or other shapes determined through optimization; and
the tendon elements run through (or not through) the tubes.

19. The structure of claim 1, wherein:
the stuffer members are tubes; and
the tendon elements are wires, each with a first bent end inserted into the first end of a stuffer member and a second bent end inserted into the second end of a different member.

20. The composite structure of claim 1, wherein one or both of the panels are solid.

21. The composite structure of claim 1, wherein one or both of the panels are mesh.

22. The composite structure of claim 1, wherein the cross-section of the stuffers as measured along their length is constant or variable.
